(19) United States
(12) Patent Application Publication
(10) Pub. No.: US 2014/0084778 A1
(43) Pub. Date: Mar. 27, 2014

(54) PLASMA DISPLAY PANEL AND METHOD FOR PRODUCING THE SAME

(71) Applicant: PANASONIC CORPORATION, Osaka (JP)

(72) Inventors: Tomokiyo Yamada, Osaka (JP); Yasutaka Tsutsui, Osaka (JP); Taishi Asano, Osaka (JP); Kenta Hosoi, Kyoto (JP); Morio Fujitani, Osaka (JP)

(73) Assignee: PANASONIC CORPORATION, Osaka (JP)

(21) Appl. No.: 13/820,688

(22) PCT Filed: Nov. 22, 2012
(86) PCT No.: PCT/JP12/07522

§ 371 Date: Mar. 4, 2013

(30) Foreign Application Priority Data
Dec. 1, 2011 (JP) 2011-263298
Dec. 16, 2011 (JP) 2011-275403
Dec. 21, 2011 (JP) 2011-279428
Dec. 21, 2011 (JP) 2011-279429

(51) Int. Cl. H01J 17/49

(52) U.S. Cl. CPC H01J 17/49
USPC 313/484

(57) ABSTRACT

A plasma display panel includes: a front plate including an image display area and an image non-display area provided outside the image display area; and a rear plate provided to be opposed to the front plate. The front plate has a substrate, and a display electrode provided over the substrate. The display electrode has, in the image display area, a stacked structure of a first electrode and a second electrode provided over the first electrode. Furthermore, the display electrode has, in at least a portion of the image non-display area, a first region and a second region provided around the first region. The first region has a single-layer structure of a second electrode. The second region has a stacked structure of a first electrode and the second electrode provided over the first electrode. The surface of the display electrode has a sparse degree between 12% and 15% (inclusive).

### TECHNICAL FIELD

The technique disclosed herein relates to a plasma display panel for use in a display device or the like, and a method for manufacturing the plasma display panel.

### BACKGROUND ART

In a method for manufacturing a plasma display panel (hereinafter, referred to as a PDP) where electrode pairs for forming display lines are arranged on a substrate, and each of the electrodes is composed of a transparent electrode and a bus electrode which has a two-layer structure of a first black layer and a main electrode layer, a technique is known which forms the first black layer and the main electrode layer in such a way that a first black layer pattern and a main electrode layer pattern are each formed by an offset printing method, and then subjected to co-firing (see PTL 1, for example).

### CITATION LIST

### Patent Literature

PTL: Unexamined Japanese Patent Publication No. 2004-185895

### SUMMARY OF THE INVENTION

A PDP disclosed herein includes: a front plate including an image display area and an image non-display area provided outside the image display area; and a rear plate provided to be opposed to the front plate. The front plate has a substrate, and a display electrode provided over the substrate. The display electrode has, in the image display area, a stacked structure of a first electrode and a second electrode provided over the first electrode. Furthermore, the display electrode has, in at least a portion of the image non-display area, a first region and a second region provided around the first region. The first region has a single-layer structure of the second electrode. The second region has a stacked structure of the first electrode and the second electrode provided over the first electrode. The surface of the display electrode has a sparse degree between 12% and 15% (inclusive).

Another PDP disclosed herein includes: a front plate including an image display area and an image non-display area provided outside the image display area; and a rear plate provided to be opposed to the front plate. The front plate has a substrate, and a display electrode provided over the substrate. The display electrode has, in the image display area, a stacked structure of a first electrode and a second electrode provided over the first electrode. Furthermore, the display electrode has, in at least a portion of the image non-display area, a first region and a second region provided around the first region. The first region has a single-layer structure of the second electrode. The second region has a stacked structure of the first electrode and the second electrode provided over the first electrode. The surface of the display electrode has a brightness as an L value between 68 and 71 (inclusive).

A method for manufacturing a PDP herein includes: forming a second pattern containing a plurality of conductive particles arranged apart from each other so as to provide gaps, on a first pattern containing a polymer and an inorganic constituent, the first pattern formed on a substrate; and then forming a first layer and a second layer from the first pattern and the second pattern respectively by co-firing the first pattern and the second pattern. In co-firing the first pattern and the second pattern, the polymer is changed to a gas by burning, and the gas is at least partially desorbed through the gaps from the first pattern.

### BRIEF DESCRIPTION OF DRAWINGS

FIG. 1 is a perspective view illustrating a PDP structure according to an embodiment.

FIG. 2 is a schematic cross-sectional view illustrating the structure of a front plate according to an embodiment.

FIG. 3 is a diagram showing a flow of manufacturing a front plate according to an embodiment.

FIG. 4A is a first view illustrating a process for manufacturing a display electrode according to an embodiment.

FIG. 4B is a second view illustrating the process for manufacturing a display electrode according to the embodiment.

FIG. 4C is a third view illustrating the process for manufacturing a display electrode according to the embodiment.

FIG. 4D is a fourth view illustrating the process for manufacturing a display electrode according to the embodiment.

FIG. 4E is a fifth view illustrating the process for manufacturing a display electrode according to the embodiment.

FIG. 4F is a sixth view illustrating the process for manufacturing a display electrode according to the embodiment.

FIG. 5 is a diagram showing a temperature profile for firing according to an embodiment.

FIG. 6A is first view illustrating a manufacturing process for firing a display electrode according to an embodiment.

FIG. 6B is second view illustrating the manufacturing process for firing a display electrode according to the embodiment.

FIG. 6C is third view illustrating the manufacturing process for firing a display electrode according to the embodiment.

FIG. 6D is fourth view illustrating the manufacturing process for firing a display electrode according to the embodiment.

FIG. 6E is fifth view illustrating the manufacturing process for firing a display electrode according to the embodiment.

FIG. 7 is a diagram showing evaluation results in an example.

FIG. 8 is a diagram showing another evaluation results in an example.

FIG. 9 is a diagram illustrating a sustain electrode common section according to an embodiment.

FIG. 10 is a diagram illustrating another sustain electrode common section according to an embodiment.

FIG. 11 is a schematic cross-sectional view illustrating the structure of a front plate according to a modification example of an embodiment.

FIG. 12 is a diagram showing the relationship between a transparent electrode thickness and film thickness ratio.

### DESCRIPTION OF EMBODIMENT

An embodiment will be described below in detail. The embodiment will be described appropriately with reference to the drawings. However, detailed descriptions more than necessary may be omitted. For example, detailed descriptions of already well known matters and repeated descriptions of substantially the same components may be omitted. This is to avoid lengthy explanations, and facilitate understanding by one skilled in the art.

It is to be noted that the inventors provide the accompanying drawings and the following description for one skilled in the art to fully understand the disclosure herein. It is not intended by the inventors that the subject matter defined in claims is limited by the disclosure herein.

### 1. Configuration of PDP 1

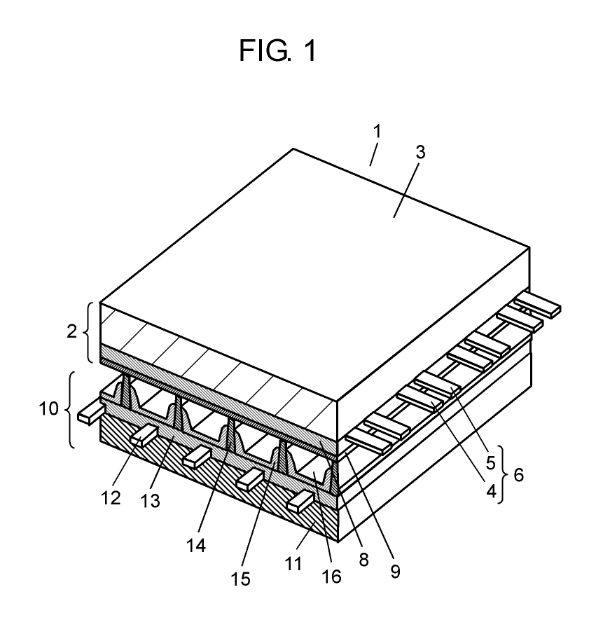

PDP 1 according to the present embodiment is an alternating-current surface discharge PDP. As shown in FIG. 1, PDP 1 is configured to have front plate 2 and rear plate 10 opposed. Front plate 2 and rear plate 10 have an outer periphery hermetically sealed with a sealing material composed of glass frit or the like. Discharge space 16 in sealed PDP 1 is filled with a discharge gas such as neon (Ne) and xenon (Xe) at a pressure of 55 kPa to 80 kPa.

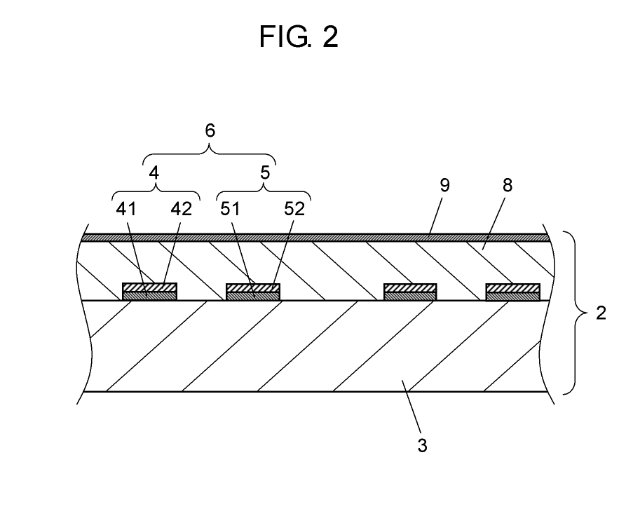

As shown in FIG. 2, front plate 2 has front glass substrate 3, display electrodes 6, dielectric layer 8, and protective layer 9. More than one display electrode 6 is placed on the surface of front glass substrate 3. Each display electrode 6 is placed parallel to the longer side of front glass substrate 3. Each display electrode 6 has one scan electrode 4 and one sustain electrode 5. The space between scan electrode 4 and sustain electrode 5 is a discharge gap. Scan electrode 4 includes black electrode 41 provided on front glass substrate 3 and white electrode 42 provided on black electrode 41. Sustain electrode 5 includes black electrode 51 provided on front glass substrate 3 and white electrode 52 provided on black electrode 51. Black electrodes 41, 51 have a black pigment in order to improve the contrast of PDP 1. White electrodes 42, 52 have silver (Ag) in order to achieve favorable conductivity. Dielectric layer 8 covers display electrode 6. Dielectric layer 8 is provided so as to generate silent discharge when an alternating-current voltage is applied to display electrode 6. Protective layer 9 covers dielectric layer 8. Protective layer 9 is required to have the function of retaining charges for the generation of discharge, and the function of emitting secondary electrons in sustain discharge. The improved charge retention performance decreases the voltage to be applied. The increased number of emitted secondary electrons decreases the driving voltage for generating sustain discharge. Protective layer 9 according to the present embodiment includes MgO.

Further, a light-shielding layer may be provided on front glass substrate 3. In addition, a transparent electrode may be provided between display electrode 6 and front glass substrate 3.

As shown in FIG. 1, rear plate 10 has rear glass substrate 11, address electrode 12, insulating layer 13, barrier rib 14, and phosphor layer 15. More than one address electrode 12 is placed on the surface of rear glass substrate 11. Each address electrode 12 is placed parallel to the shorter side of rear glass substrate 11. In other words, each address electrode 12 is placed in a direction orthogonal to display electrode 6. Each address electrode 12 has silver (Ag) in order to achieve favorable conductivity.

Rear plate 10 includes insulating layer 13 for covering more than one address electrode 12. Insulating layer 13 includes a glass constituent and a filler. The ratio of the glass constituent to the sum of the glass constituent and filler is between 25 weight % and 35 weight % (inclusive).

Rear plate 10 includes barrier rib 14 for separating the discharge space. Barrier rib 14 is provided on insulating layer 13. Barrier rib 14 is placed parallel to address electrode 12. Barrier rib 14 is placed between address electrode 12 and address electrode 12. It is to be noted that a barrier rib may be further included which is parallel to display electrode 6. Barrier rib 14 includes a glass constituent and a filler. The ratio of the glass constituent to the sum of the glass constituent and filler is between 70 weight % and 90 weight % (inclusive).

Rear plate 10 includes phosphor layer 15. Phosphor layer 15 is provided on the surface of insulating layer 13 and the side surfaces of barrier rib 14. Phosphor layer 15 includes a red phosphor layer which emits red light, a blue phosphor layer which emits blue light, and a green phosphor layer which emits green light. Phosphor layer 15 has a luminescent center excited by ultraviolet light.

Discharge cells are formed in positions in which display electrodes 6 cross address electrodes 12. Pixels for color display are formed by discharge cells including phosphor layers 15 which emit light in red, discharge cells including phosphor layers 15 which emit light in blue, and discharge cells including phosphor layers 15 which emit light in green.

### 2. Method for Manufacturing PDP 1

2-1. Method for Forming Front Plate 2

2-1-1. Display Electrode 6

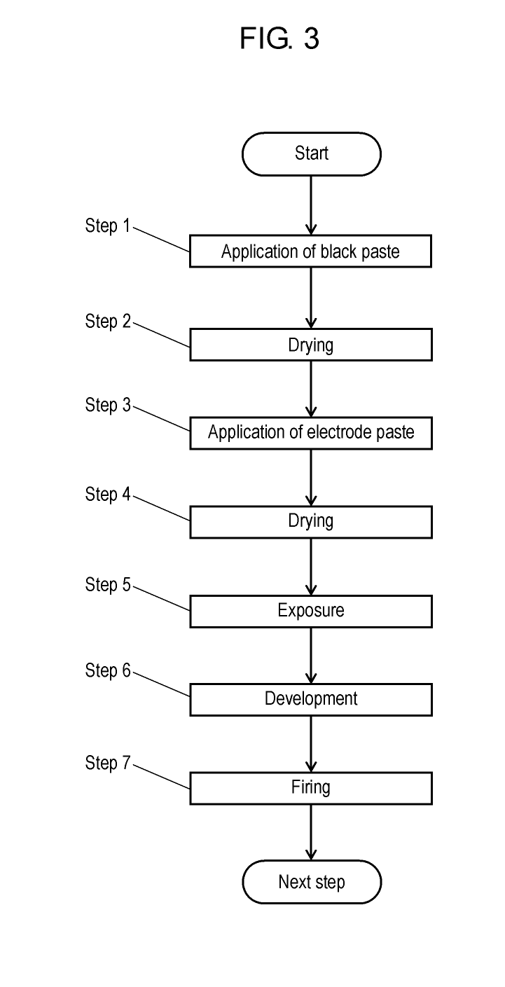

Scan electrode 4 and sustain electrode 5 are formed on front glass substrate 3 in accordance with the flow shown in FIG. 3.

(Application of Black Paste)

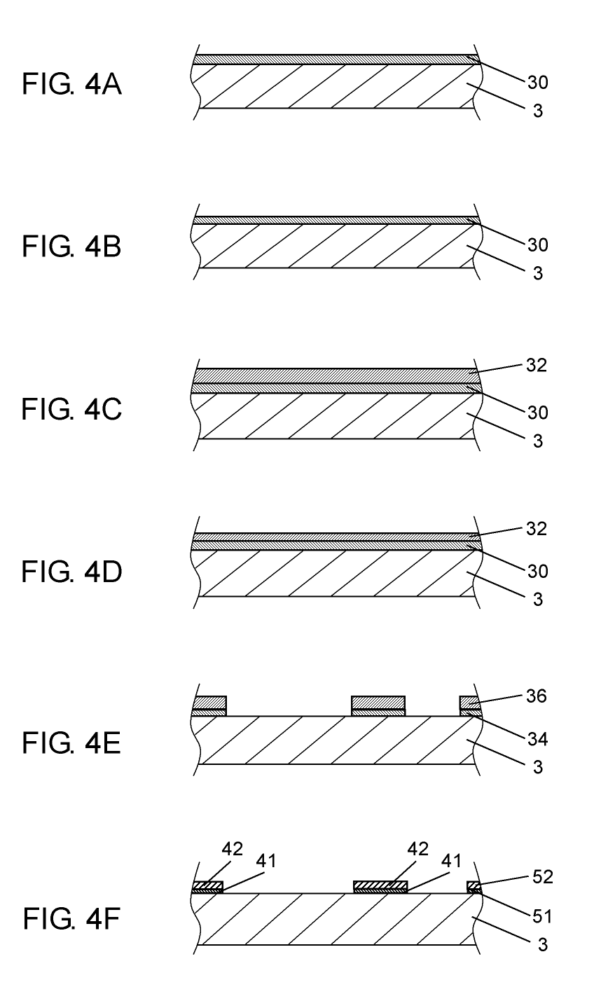

In step 1, a black past is applied onto front glass substrate 3 by a screen printing method or the like. As shown in FIG. 4A, the black paste applied onto front glass substrate 3 constitutes black paste layer 30.

(Black Paste)

The black paste contains glass frit for binding a black pigment to one another, and a photopolymerizable monomer, a photopolymerization initiator, a resin, and a solvent, etc.

A ruthenium oxide, a cobalt oxide, a nickel oxide, or the like is used as the black pigment.

The glass frit contains 20 weight % to 50 weight % of dibismuth trioxide (Bi₂O₃), 5 weight % to 35 weight % of diboron trioxide (B₂O₃), 10 weight % to 20 weight % of zinc oxide (ZnO), and 5 weight % to 20 weight % of barium oxide (BaO). Furthermore, the glass frit may contain molybdenum trioxide (MoO₃), tungsten trioxide (WO₃), etc.

If the content of Bi₂O₃ is excessively high, the coefficient of thermal expansion is increased, and the softening point is decreased. Therefore, Bi₂O₃ preferably accounts for 20 weight % to 50 weight %. Moreover, Bi₂O₃ more preferably accounts for 30 weight % to 45 weight %. The excessively high content of B₂O₃ for forming a glass framework decreases the coefficient of thermal expansion and increases the softening point. Therefore, B₂O₃ preferably accounts for 5 weight % to 35 weight %. Moreover, B₂O₃ more preferably accounts for 5 weight % to 30 weight %.

If the content of ZnO is excessively high, the coefficient of thermal expansion is increased, and the transparency is damaged. Therefore, ZnO preferably accounts for 10 weight % to 20 weight %.

The excessively high content of BaO increases the softening point. Therefore, BaO preferably accounts for 5 weight % to 20 weight %.

The glass frit preferably has an average particle size of 4.0 μm or less in order to improve the adhesion between black electrode 41 and front glass substrate 3. Moreover, the average particle size is more preferably 1 μm to 3 μm. In addition, the maximum particle size of the glass frit is preferably 10 μm or less in order to achieve a balance between the adhesion force and the linearity of ends of black electrode 41. Moreover, the maximum particle size is more preferably 5 μm to 8 μm.

It is to be noted that the average particle size means a volume-cumulative average size (D50) in the present embodiment. Laser diffraction particle size distribution measurement system MT-3300 (from Nikkiso Co., Ltd.) was used for the measurement of the average particle size.

Used as the photopolymerizable monomer are 2-hydroxyethyl acrylate, 2-hydroxypropyl acrylate, diethylene glycol diacrylate, triethylene glycol diacrylate, polyethylene glycol diacrylate, polyurethane diacrylate, trimethylol propane triacrylate, pentaerythritol triacrylate, pentaerythritol tetraacrylate, trimethylol propane ethylene oxide-modified triacrylate, trimethylol propane propylene oxide-modified triacrylate, dipentaerythritol pentaacrylate, dipentaerythritol hexaacrylate, etc. One of these monomers can be used by itself. Alternatively, two or more of the monomers can be used in combination with each other.

The photopolymerization initiator is thermally inactive, but supposed to generate a free radical when the initiator is exposed to light of a predetermined wavelength at a temperature of 185° C. or lower. The photopolymerization initiator contains a substituted or unsubstituted polynuclear quinone as a compound having two intramolecular rings in a conjugated carbon ring. Examples of the photopolymerization initiator used include 9,10-anthraquinone, 2-methylanthraquinone, 2-ethylanthraquinone, 2-t-butylanthraquinone, octamethylanthraquinone, 1,4-naphthoquinone, 9,10-phenanthrenequinone, benzo[a]anthracene-7,12-dione, 2,3-naphthacene-5,12-dione, 2-methyl-1,4-naphthoquinone, 1,4-dimethylanthraquinone, 2,3-dimethylanthraquinone, 2-phenylanthraquinone, 2,3-diphenylanthraquinone, retene quinone, 7,8,9,10-tetrahydro-naphthacene-5,12-dione, and 1,2,3,4-tetrahydrobenzo[a]anthracene-7,12-dione.

An acrylic polymer and a cellulosic polymer or the like are used as the resin. At least one selected from polybutylacrylates, polymethacrylates, and the like can be contained as the acrylic polymer. At least one selected from ethyl cellulose, hydroxy cellulose, and hydroxypropyl cellulose can be contained as the cellulosic polymer.

Used as the solvent are terpenes such as α-, β-, and γ-terpineols; ethylene glycol monoalkyl ethers, ethylene glycol dialkyl ethers, diethylene glycol monoalkyl ethers, diethylene glycol dialkyl ethers, ethylene glycol monoalkyl ether acetates, ethylene glycol dialkyl ether acetates, diethylene glycol monoalkyl ether acetates, diethylene glycol dialkyl ether acetates, propylene glycol monoalkyl ethers, propylene glycol dialkyl ethers, propylene glycol monoalkyl ether acetates, propylene glycol dialkyl ether acetates; and alcohols such as methanol, ethanol, isopropanol, and 1-butanol. One of these solvents can be used by itself. Alternatively, two or more of the solvents can be used in combination with each other.

These materials are mixed and dispersed with the use of a disperser such as a triple roll mill, a ball mill, or a sand mill, thereby preparing the black paste.

(Drying of Black Paste Layer 30)

Next, in step 2, the solvent in the black paste layer is removed in a baking oven. Examples of the baking oven include heating ovens with heaters, reduced-pressure baking ovens, and infrared baking ovens. The atmosphere in the drying may be the atmospheric air or an inert gas. The drying temperature is on the order of 80° C. to 200° C. The drying time is on the order of 3 minutes to 30 minutes. As shown in FIG. 4B, the drying reduces the film thickness of black paste layer 30. The film thickness of dried black paste layer 30 is appropriately set in the range on the order of 4 μm to 8 μm. The drying temperature and the drying time are appropriately set depending on the type, amount, etc. of the solvent contained in black paste layer 30.

(Application of Electrode Paste)

Next, in step 3, an electrode past is applied onto black paste layer 30 by a screen printing method or the like. As shown in FIG. 4C, the electrode paste applied onto black paste layer 30 constitutes electrode paste layer 32. The film thickness of electrode paste layer 32 is appropriately set in the range on the order of 10 μm to 15 μm.

(Electrode Paste)

The electrode paste contains glass frit for binding conductive particles to each other, and a photopolymerizable monomer, a photopolymerization initiator, a resin, and a solvent, etc. More specifically, the electrode paste contains the conductive particles containing 50 weight % to 70 weight % (inclusive) thereof, the glass frit containing 1 weight % to 10 weight % (inclusive) thereof, the resin containing 5 weight % to 15 weight % (inclusive) thereof, the photopolymerizable monomer containing 5 weight % to 15 weight % (inclusive) thereof, and the solvent containing 5 weight % to 20 weight % (inclusive) thereof. Further, the electrode paste may contain a rheology modifier.

Silver (Ag), copper (Cu), and the like are used as the conductive particles. The conductive particles preferably have an average particle size between 1 μm and 3 μm (inclusive). This is because the conductive particles less than 1 μm in average particle size are likely to be aggregated in the electrode paste. This is because the conductive particles greater than 3 μm in average particle size have difficulty with uniform dispersion in the electrode paste.

Moreover, the conductive particles more preferably have small particles between 1 μm and 1.5 μm (inclusive) in average particle size and large particles between 2 μm and 3 μm (inclusive) in average particle size. The small particles stuck in the gaps between the large particles further reduce defects of white electrodes 42, 52.

The glass frit contains at least 20 weight % to 50 weight % of dibismuth trioxide (Bi₂O₃), 5 weight % to 35 weight % of diboron trioxide (B₂O₃), 10 weight % to 20 weight % of zinc oxide (ZnO), and 5 weight % to 20 weight % of barium oxide (BaO). Furthermore, the glass frit may contain molybdenum trioxide (MoO₃), tungsten trioxide (WO₃), etc.

If the content of Bi₂O₃ is excessively high, the coefficient of thermal expansion is increased, and the softening point is decreased. Therefore, Bi₂O₃ preferably accounts for 20 weight % to 50 weight %. Moreover, Bi₂O₃ more preferably accounts for 30 weight % to 45 weight %. The excessively high content of B₂O₃ for forming a glass framework decreases the coefficient of thermal expansion and increases the softening point. Therefore, B₂O₃ preferably accounts for 5 weight % to 35 weight %. Moreover, B₂O₃ more preferably accounts for 5 weight % to 30 weight %.

If the content of ZnO is excessively high, the coefficient of thermal expansion is increased, and the transparency is damaged. Therefore, ZnO preferably accounts for 10 weight % to 20 weight %.

The excessively high content of BaO increases the softening point. Therefore, BaO preferably accounts for 5 weight % to 20 weight %.

The glass frit preferably has an average particle size of 4.0 μm or less in order to improve the adhesion between white electrodes 42, 52 and black electrodes 41, 42. Moreover, the average particle size is more preferably 1 μm to 3 μm. In addition, the maximum particle size of the glass frit is preferably 10 μm or less in order to achieve a balance between the adhesion and the linearity of ends of white electrodes 42, 52. Moreover, the maximum particle size is more preferably 5 μm to 8 μm.

Used as the photopolymerizable monomer are 2-hydroxyethyl acrylate, 2-hydroxypropyl acrylate, diethylene glycol diacrylate, triethylene glycol diacrylate, polyethylene glycol diacrylate, polyurethane diacrylate, trimethylol propane triacrylate, pentaerythritol triacrylate, pentaerythritol tetraacrylate, trimethylol propane ethylene oxide-modified triacrylate, trimethylol propane propylene oxide-modified triacrylate, dipentaerythritol pentaacrylate, dipentaerythritol hexaacrylate, etc. One of these monomers can be used by itself. Alternatively, two or more of the monomers can be used in combination with each other.

The photopolymerization initiator is thermally inactive, but supposed to generate a free radical when the initiator is exposed to light of a predetermined wavelength at a temperature of 185° C. or lower. The photopolymerization initiator contains a substituted or unsubstituted polynuclear quinone as a compound having two intramolecular rings in a conjugated carbon ring. Examples of the photopolymerization initiator used include 9,10-anthraquinone, 2-methylanthraquinone, 2-ethylanthraquinone, 2-t-butylanthraquinone, octamethylanthraquinone, 1,4-naphthoquinone, 9,10-phenanthrenequinone, benzo[a]anthracene-7,12-dione, 2,3-naphthacene-5,12-dione, 2-methyl-1,4-naphthoquinone, 1,4-dimethylanthraquinone, 2,3-dimethylanthraquinone, 2-phenylanthraquinone, 2,3-diphenylanthraquinone, retene quinone, 7,8,9,10-tetrahydro-naphthacene-5,12-dione, and 1,2,3,4-tetrahydrobenzo[a]anthracene-7,12-dione.

An acrylic polymer and a cellulosic polymer or the like are used as the resin. At least one selected from polybutylacrylates, polymethacrylates, and the like can be contained as the acrylic polymer. At least one selected from ethyl cellulose, hydroxy cellulose, and hydroxypropyl cellulose can be contained as the cellulosic polymer.

Used as the solvent are terpenes such as α-, β-, and γ-terpineols; ethylene glycol monoalkyl ethers, ethylene glycol dialkyl ethers, diethylene glycol monoalkyl ethers, diethylene glycol dialkyl ethers, ethylene glycol monoalkyl ether acetates, ethylene glycol dialkyl ether acetates, diethylene glycol monoalkyl ether acetates, diethylene glycol dialkyl ether acetates, propylene glycol monoalkyl ethers, propylene glycol dialkyl ethers, propylene glycol monoalkyl ether acetates, propylene glycol dialkyl ether acetates; and alcohols such as methanol, ethanol, isopropanol, and 1-butanol. One of these solvents can be used by itself. Alternatively, two or more of the solvents can be used in combination with each other.

As the rheology modifier, fumed silica, modified urea (a product obtained by a reaction between an isocyanate monomer or an adduct thereof and an organic amine), etc. can be used.

These materials are mixed and dispersed with the use of a disperser such as a triple roll mill, a ball mill, or a sand mill, thereby preparing the electrode paste.

(Drying of Electrode Paste Layer 32)

Next, in step 4, the solvent in electrode paste layer 32 is removed in a baking oven. Examples of the baking oven include heating ovens with heaters, reduced-pressure baking ovens, and infrared baking ovens. The atmosphere in the drying may be the atmospheric air or an inert gas. The drying temperature is on the order of 80° C. to 200° C. The drying time is on the order of 3 minutes to 30 minutes. As shown in FIG. 4D, the drying reduces the film thickness of electrode paste layer 32. The film thickness of dried electrode paste layer 32 is appropriately set in the range on the order of 4 μm to 8 μm. The drying temperature and the drying time are appropriately set depending on the type, amount, etc. of the solvent contained in electrode paste layer 32.

(Exposure)

Next, in step 5, black paste layer 30 and electrode paste layer 32 are exposed to light together. First, black paste layer 30 and electrode paste layer 32 are irradiated with light through a photomask which has a mask pattern for display electrode 6 formed from chromium or the like on a glass plate. The wavelength of the light is a wavelength which reacts the photopolymerization initiator contained in black paste layer 30 and electrode paste layer 32. Typically, the wavelength is on the order from 250 nm to 450 nm. The region irradiated with the light in black paste layer 30 and electrode paste layer 32 is cured by polymerization of the photopolymerizable monomer.

(Development)

Next, in step 6, black paste layer 30 and electrode paste layer 32 are developed. For the developer, an alkaline developer is used which is compatible with black paste layer 30 and electrode paste layer 32. Specifically, a sodium carbonate solution, a potassium hydroxide solution, TMAH (tetramethyl ammonium hydroxide), or the like is used. The developer is sprayed onto black paste layer 30 and electrode paste layer 32 to leave the region irradiated with light and remove the region irradiated with no light as shown in FIG. 4E. More specifically, formed are pre-firing (unfired) black electrode pattern 34 and white electrode pattern 36. Finally, water washing is carried out to remove contamination, etc. adhering to front glass substrate 3. In this case, black electrode pattern 34 contains therein a polymer, glass, and a black pigment. The polymer herein refers to both the polymer produced by the polymerization of the photopolymerizable monomer and the resin. White electrode pattern 36 contains therein a polymer, glass, and conductive particles. The polymer herein refers to both the polymer produced by the polymerization of the photopolymerizable monomer and the resin.

(Firing)

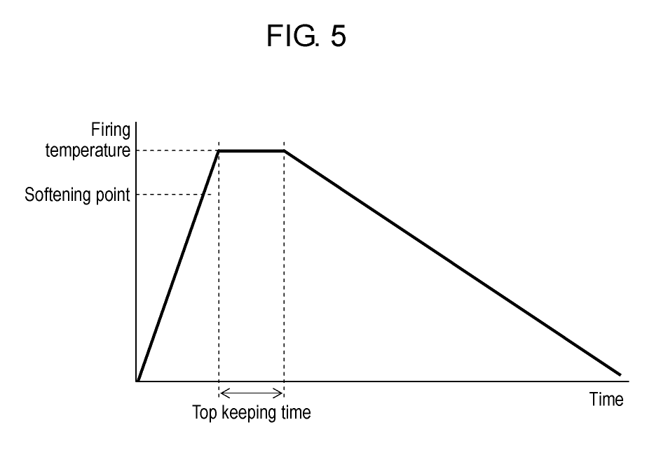

Next, in step 7, black electrode pattern 34 and white electrode pattern 36 are subjected to firing in a baking oven. Examples of the baking oven include a heating oven with heaters. The atmosphere in the firing preferably contains oxygen. The oxygen is intended to burn the resin. More specifically, the atmosphere may be the atmospheric air. The firing is carried out in accordance with, as an example, the temperature profile shown in FIG. 5. The softening point refers to a temperature at which the glass frit contained in black electrode pattern 34 and white electrode pattern 36 turns soft. As shown in FIG. 5, first, the temperature is increased from room temperature to the firing temperature. The increase in temperature burns the polymer remaining in black electrode pattern 34 and white electrode pattern 36. Next, the profile reaches a top keeping period. More specifically, the temperature is kept the firing temperature for the top keeping period. The glass frit is softened by keeping at the firing temperature. More specifically, the black pigment in black electrode pattern 34 is bound by the glass. The conductive particles in the white electrode pattern are bound by the softened glass frit. The firing temperature falls within the temperature range from 450° C. to 650° C. More preferably, the firing temperature falls within the temperature range from 550° C. to 600° C. The top keeping period is on the order of 10 minutes to 120 minutes. As shown in FIG. 4F, black electrodes 41, 51 and white electrodes 42, 52 are formed when the firing is completed. Display electrode 6 has a film thickness on the order of 4 μm to 7 μm.

(State Change in Firing)

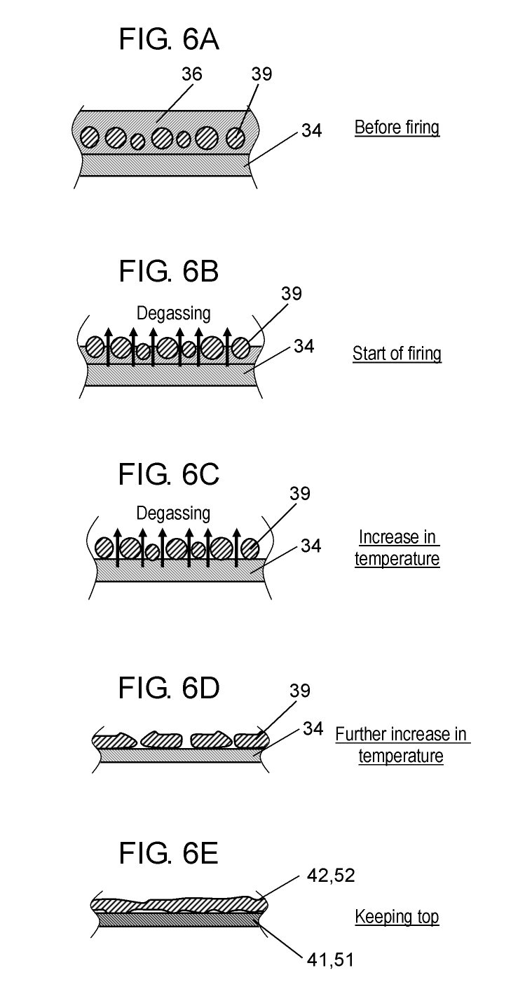

As shown in FIG. 6A, plurality of conductive particles 39 remain in white electrode pattern 36 before the firing. Gaps are formed between conductive particle 39 and conductive particle 39. It is to be noted that the glass frit is not shown for the sake of explanation.

As shown in FIG. 6B, the polymer is removed progressively from white electrode pattern 36 when the firing is started. In addition, the polymer is also removed from black electrode pattern 34. The polymer is burned, and thereby changed to a gas such as carbon dioxide and water. The gasified polymer is desorbed from white electrode pattern 36 and black electrode pattern 34. More specifically, the removal of the polymer means degassing. In the present embodiment, gaps are formed between conductive particle 39 and conductive particle 39. Therefore, the gaps make it easy to remove the polymer from black electrode pattern 34.

As shown in FIG. 6C, the increased temperature removes almost all of the polymer in white electrode pattern 36. The polymer is further removed from black electrode pattern 34.

As shown in FIG. 6D, the further increased temperature starts sintering of conductive particles 39. This is because the surfaces of conductive particles 39 are activated. In addition, almost all of the polymer is removed from black electrode pattern 34.

As shown in FIG. 6E, for the top keeping period, conductive particles 39 are progressively sintered, and changed into a film state. More specifically, white electrodes 42, 52 are formed. In addition, black electrodes 41, 51 are formed.

More specifically, in the present embodiment, the polymer removal from black electrode pattern 34 as the lower layer is facilitated because gaps are formed between conductive particle 39 and conductive particle 39 in white electrode pattern 36 as the upper layer. Thus, degassing for black electrode pattern 34 is facilitated.

Therefore, in the case of PDP 1 according to the present embodiment, the generation of blister, etc. due to black electrode pattern 34 is suppressed even when black electrode pattern 34 and white electrode pattern 36 are subjected to co-firing.

Further, more preferably, while the surface with black electrode pattern 34 and white electrode pattern 36 formed is faced up, front glass substrate 3 is heated from the top and bottom of front glass substrate 3, in such a way that the temperature of heating from the top of front glass substrate 3 is higher than the temperature of heating from the bottom of front glass substrate 3 until burning the polymer contained in black electrode pattern 34 and then the temperature of heating from the top of front glass substrate 3 is lower than the temperature of heating from the bottom of front glass substrate 3. This is because degassing for black electrode pattern 34 is further facilitated.

2-1-2. Dielectric Layer 8

For the material of dielectric layer 8, a dielectric paste is used which contains dielectric glass frit, a resin, a solvent, etc. First, the dielectric paste is applied for a predetermined thickness onto front glass substrate 3 by a die coating method or the like. The applied dielectric paste coats scan electrode 4 and sustain electrode 5. Next, the dielectric paste is dried in a temperature range of, for example, 100° C. to 250° C. in a baking oven. The drying removes the solvent in the dielectric paste. Finally, the dielectric paste is subjected to firing in a temperature range of, for example, 400° C. to 550° C. in a baking oven. The firing removes the resin in the dielectric paste. The firing melts the dielectric glass frit. The melted dielectric glass frit is vitrified again after the firing. In accordance with the step described above, dielectric layer 8 is formed.

In addition to the method described above, a screen printing method, a spin coating method, and the like can be used. Alternatively, a film to serve as dielectric layer 8 can be formed by a CVD (Chemical Vapor Deposition) method or the like, without using the dielectric paste.

2-1-3. Protective Layer 9

Protective layer 9 is formed by, as an example, an EB (Electron Beam) deposition device. When protective layer 9 contains MgO and CaO, the materials for protective layer 9 are a MgO pellet of single-crystal MgO and a CaO pellet of single-crystal CaO. Thus, pellets may be selected in accordance with the composition of protective layer 9. Furthermore, as impurities, aluminum (Al), silicon (Si), etc. may be added to the MgO pellet or the CaO pellet.

First, the MgO pellet and CaO pellet placed in a deposition room of the EB deposition device are irradiated with electron beams. The surfaces of the MgO pellet and CaO pellet energized by the electron beams are evaporated gradually. MgO evaporated from the MgO pellet and CaO evaporated from the CaO pellet adhere onto front glass substrate 3 moving in the deposition room. More specifically, the MgO and the CaO adhere onto dielectric layer 8 through a mask with an opened area for a display area. Front glass substrate 3 is heated to about 300° C. by a heater. The pressure in the deposition room is kept so as to have an oxygen partial pressure of about 3E-2 Pa, by reduction in pressure to about 10 ⁻⁴ Pa and then supply of an oxygen gas. The film thickness of protective layer 9 is adjusted to fall within a predetermined range, depending on the intensity of the electron beams, the pressure in the deposition room, the movement speed of front glass substrate 3, etc.

In accordance with the steps described above, front plate 2 is completed which has the predetermined constituent members on front glass substrate 3.

2-2. Method for Forming Rear Plate 10

2-2-1. Address Electrode 12

Address electrodes 12 are formed on rear glass substrate 11 by a photolithographic method. For the material of address electrodes 12, an address electrode paste is used which contains silver (Ag) particles as conductors, glass frit for binding the silver particles to each other, a photosensitive resin, a solvent, etc.

First, the address electrode paste is applied for a predetermined thickness onto rear glass substrate 11 by a screen printing method or the like. Next, the address electrode paste is dried in a temperature range of, for example, 100° C. to 250° C. in a baking oven. The drying removes the solvent in the address electrode paste. The address electrode paste is exposed to light through a photomask, for example, with more than one rectangular pattern formed. Next, the address electrode paste is developed. When a positive-type photosensitive resin is used, the exposed section is removed. The remaining address electrode paste serves as the address electrode pattern. Finally, the address electrode pattern is subjected to firing in a temperature range of, for example, 400° C. to 550° C. in a baking oven. The firing removes the photosensitive resin in the address electrode pattern. The firing melts the glass frit in the address electrode pattern. The melted glass frit is vitrified again after the firing. In accordance with the step described above, address electrodes 12 are formed.

In addition to the method described above, methods can be also used in which a metal film is formed by a sputtering method, a deposition method, or the like, and then subjected to patterning.

2-2-2. Insulating Layer 13

For the material of insulating layer 13, an insulating paste is used which contains glass frit, a filler, a resin and a solvent, etc. The ratio of the glass frit to the sum of the glass frit and filler is between 25 weight % and 35 weight % (inclusive).

First, the insulating paste is applied for a predetermined thickness onto rear glass substrate 11 by a screen printing method or the like. The applied insulating paste coats address electrode 12. Next, the insulating paste is dried in a temperature range of, for example, 100° C. to 250° C. in a baking oven. The drying removes the solvent in the insulating paste. Finally, the insulating paste is subjected to firing in a temperature range of, for example, 400° C. to 550° C. in a baking oven. The firing removes the resin in the insulating paste. In addition, the firing melts the glass frit. On the other hand, the filler is not melted even by the firing. The melted glass frit turns into a glass constituent again after the firing. Thus, insulating layer 13 is adapted to have the filler dispersed in the glass constituent. In accordance with the step described above, insulating layer 13 is formed. In addition to the screen printing method, a spin coating method, die coating method, and the like can be used.

2-2-3. Barrier Rib 14

Barrier ribs 14 are formed by a photolithographic method. For the material of the barrier rib 14, an barrier rib paste is used which contains a filler, glass frit for binding the filler, a photosensitive resin, a solvent, etc. The ratio of the glass frit to the sum of the glass frit and filler is between 80 weight % and 85 weight % (inclusive).

First, the barrier rib paste is applied for a predetermined thickness onto insulating layer 13 by a die coating method or the like. Next, the barrier rib paste is dried in a temperature range of, for example, 100° C. to 250° C. in a baking oven. The drying removes the solvent in the barrier rib paste. Next, the barrier rib paste is exposed to light through a photomask, for example, in a hanging rack pattern. Next, the barrier rib paste is developed. When a positive-type photosensitive resin is used, the exposed section is removed. The remaining barrier rib paste serves as a barrier rib pattern. Finally, the barrier rib pattern is subjected to firing in a temperature range of, for example, 500° C. to 600° C. in a baking oven. The firing removes the photosensitive resin in the barrier rib pattern. The firing melts the glass frit in the barrier rib pattern. On the other hand, the filler is not melted even by the firing. The melted glass frit turns into a glass constituent again after the firing. Thus, barrier ribs 14 are adapted to have the filler dispersed in the glass constituent. In accordance with the step described above, barrier ribs 14 are formed.

2-2-4. Phosphor Layer 15

For the material of phosphor layer 15, a phosphor paste is used which contains phosphor particles, a binder, a solvent, etc.

First, the phosphor paste is applied for a predetermined thickness by a dispensing method or the like onto insulating layer 13 between adjacent barrier ribs 14 and onto the side surfaces of barrier ribs 14. Next, the solvent in the phosphor paste is removed in a baking oven. Finally, the phosphor paste is subjected to firing at a predetermined temperature in a baking oven. More specifically, the resin in the phosphor paste is removed. In accordance with the step described above, phosphor layers 15 are formed. In addition to the dispensing method, a screen printing method and the like can be used.

In accordance with the steps described above, rear plate 10 is completed which has the predetermined constituent members on rear glass substrate 11.

2-3. Method for Assembling Front Plate 2 and Rear Plate 10

First, a sealing material (not shown) is formed on the periphery of rear plate 10 by a dispensing method. For the material of the sealing material (not shown), a sealing paste is used which contains glass frit, a binder, a solvent, etc. Next, the solvent in the sealing paste is removed in a baking oven. Next, front plate 2 and rear plate 10 are opposed so that display electrode 6 and address electrode 12 are orthogonal to each other. Next, the periphery between front plate 2 and rear plate 10 is sealed with glass frit. Finally, discharge space 16 is filled with a discharge gas containing Ne, Xe, or the like. As described above, front plate 2 and rear plate 10 are assembled to complete PDP 1.

### 3. Example

Prepared was a 42-inch diagonal PDP adapted to high-definition television. The height of a barrier rib was 0.15 mm. The interval between barrier ribs (cell pitch) was 0.15 mm. The interelectrode distance between display electrodes was 0.06 mm. A Ne—Xe mixed gas with the Xe content of 15 volume % was used for sealing to have an internal pressure of 60 kPa. Further, the thickness of a glass substrate was 1.8 mm. The film thickness of a dielectric layer was 20 μm. The method for manufacturing the PDP is as described above.

The following four types of electrode pastes were used in the example. The composition ratio of silver in the electrode paste is reduced from samples 1 to 4.

Sample 1 refers to an electrode paste which has a value of 0.245 obtained by dividing the total weight of a resin and a photopolymerizable monomer by the weight of silver.

Sample 2 refers to an electrode paste which has a value of 0.286 obtained by dividing the total weight of the resin and photopolymerizable monomer by the weight of silver.

Sample 3 refers to an electrode paste which has a value of 0.332 obtained by dividing the total weight of the resin and photopolymerizable monomer by the weight of silver.

Sample 4 refers to an electrode paste which has a value of 0.380 obtained by dividing the total weight of the resin and photopolymerizable monomer by the weight of silver.

3-1. Evaluation

3-1-1. Relationship between L Value and Defect

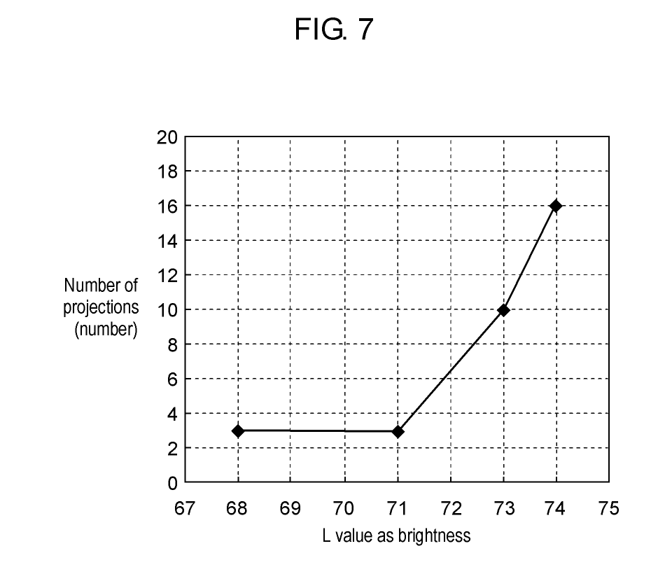

The inventors performed an evaluation of front glass substrate 3 with dielectric layer 8 formed on display electrode 6. Specifically, the relationship was evaluated between the L value of display electrode 6 and a defect generated in dielectric layer 8. As shown in FIG. 7, the L value was 74 when the electrode paste of sample 1 was used. In addition, the number of projections generated in dielectric layer 8 was 16.

The L value was 73 when the electrode paste of sample 2 was used. In addition, the number of projections generated in dielectric layer 8 was 10.

The L value was 71 when the electrode paste of sample 3 was used. In addition, the number of projections generated in dielectric layer 8 was 3.

The L value was 68 when the electrode paste of sample 4 was used. In addition, the number of projections generated in dielectric layer 8 was 3.

It is to be noted that the L value means an L* value in the CIE 1976 (L*, a*, b*) color space in the present embodiment. The L value is measured with the use of, for example, a spectrophotometric color difference meter: NF999 from NIPPON DENSHOKU INDUSTRIES CO., LTD. In addition, the L value refers to a value in an area of display electrode 6 coated with no dielectric layer 8.

It is determined that the number of projections in dielectric layer 8 is smaller in the case of using the electrode paste of sample 3 or sample 4. More specifically, when display electrode 6 has an L value between 68 and 71 (inclusive), the decrease in manufacturing yield is suppressed while reducing the manufacturing cost of PDP 1.

3-1-2. Relationship between Sparse degree and Defect

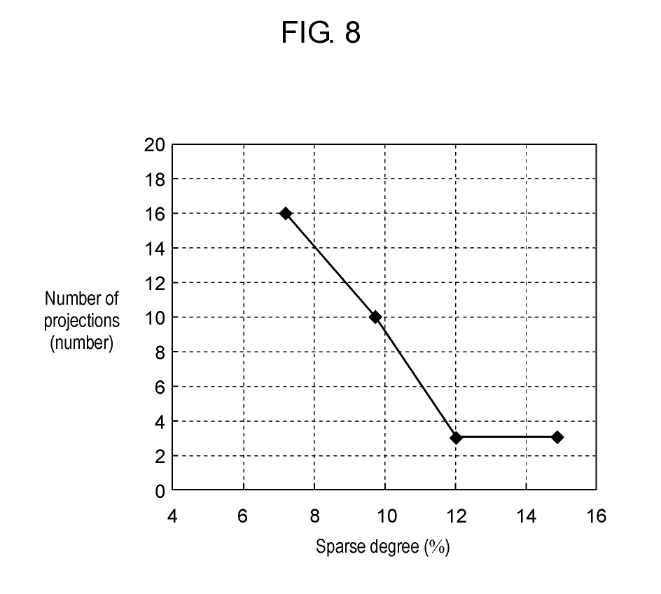

The inventors performed an evaluation of front glass substrate 3 with dielectric layer 8 formed on display electrode 6. Specifically, the relationship was evaluated between the sparse degree of display electrode 6 and a defect generated in dielectric layer 8. As shown in FIG. 8, the sparse degree was 7.2% when the electrode paste of sample 1 was used. In addition, the number of projections generated in dielectric layer 8 was 16.

The sparse degree was 9.7% when the electrode paste of sample 2 was used. In addition, the number of projections generated in dielectric layer 8 was 10.

The sparse degree was 12% when the electrode paste of sample 3 was used. In addition, the number of projections generated in dielectric layer 8 was 3.

The sparse degree was 15% when the electrode paste of sample 4 was used. In addition, the number of projections generated in dielectric layer 8 was 3.

The sparse degree of display electrode 6 is measured as follows. First, the surface of display electrode 6 is imaged with an optical microscope included in coaxial epi-illumination. The magnification is 1000 as an example. The image is captured in an 8-bit gradation into CCD (Charge Coupled Devices) of horizontal 500 pixels and vertical 500 pixels.

The shot image is expressed by 256 shades of gray (from 0 to 255 gradation) from the 8-bit gradation. First, a gain adjustment is made for an average of 128 shades of gray over the entire image. Next, an averaging procedure or the like is carried out for noise removal. The surface of display electrode 6 has sparse area expressed as a dark section in the image. Next, binarization processing is executed. In the present embodiment, the threshold value is set at 162 shades of gray. The pixels from 0 to 162 gradation are referred to as black. The pixels from 163 to 255 gradation are referred to as white. In the present embodiment, the number of pixels in the area occupied by the black is divided by the number of pixels in the entire shot image, and multiplied by 100 to obtain the sparse degree (%).

In addition, the sparse degree refers to a value measured in the area of display electrode 6 coated with no dielectric layer 8. It is to be noted that the shooting condition of the optical microscope, the CCD size for image capture, the image processing method, etc. can be appropriately changed depending on the film thickness, etc. of the object to be evaluated.

It is determined that the number of projections in dielectric layer 8 is smaller in the case of using the electrode paste of sample 3 or sample 4. More specifically, when display electrode 6 has a sparse degree between 12% and 15% (inclusive), the decrease in manufacturing yield is suppressed while reducing the manufacturing cost of PDP 1.

3-1-3. Consideration

It is considered that the phenomenon of the reduced number of projections in dielectric layer 8 is due to the fact that the volume of the silver particles as conductive particles is reduced to form gaps between the silver particles.

However, the rheology of the electrode paste is varied simply by reducing the volume of the conductive particles. When the rheology of the electrode paste is varied, the condition for applying the electrode paste will be varied. Thus, difficulty will be created in the stable application of the electrode paste. Therefore, the reduced volume of the conductive particles is replaced by the photopolymerizable monomer, the resin, and the solvent in the present embodiment. Furthermore, the rheology is adjusted by the content of the rheology modifier.

### 4. Configuration of Image Non-Display Area

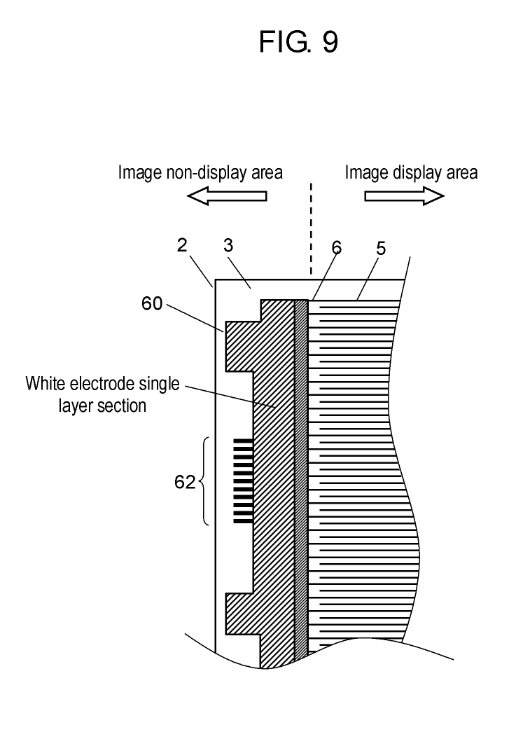

Typically, a unipotential driving waveform is applied to each of sustain electrodes 5. As shown in FIG. 9, a sustain electrode common section 60 with sustain electrodes 5 shared is provided between sustain electrodes 5 included in display electrodes 6 and a terminal section 62. Conventionally, the sustain electrode common section 60 has a stacked structure of black electrodes and white electrodes.

However, when black electrode pattern 34 and white electrode pattern 36 are subjected to firing in the same step, a phenomenon is produced in which some constituents in black electrode pattern 34 penetrate into white electrode pattern 36 to block the silver constituent in white electrode pattern 36 from being bound to one another. For this reason, it has been found that the resistance value of the stacked structure of black electrodes and white electrodes is higher than the resistance value of a single layer of a white electrode obtained by forming white electrode pattern 36 directly on front glass substrate 3, followed by firing. In addition, this phenomenon has been also confirmed in the white electrodes and black electrodes according to the present embodiment.

For this reason, sustain electrode common section 60 and terminal section 62 cause a thermal loss by heat generation from the high resistances. Moreover, there is a possibility of causing defects such as cracking in the substrate. This problem becomes pronounced as the PDP is, as an image display device, progressively reduced in frame thickness. This is because sustain electrode common section 60 is reduced in area.

Therefore, as shown in FIG. 9, sustain electrode common section 60 at least partially has a single-layer structure of only the white electrode in the present embodiment. This configuration suppresses the increase in resistance and heat generation in sustain electrode common section 60.

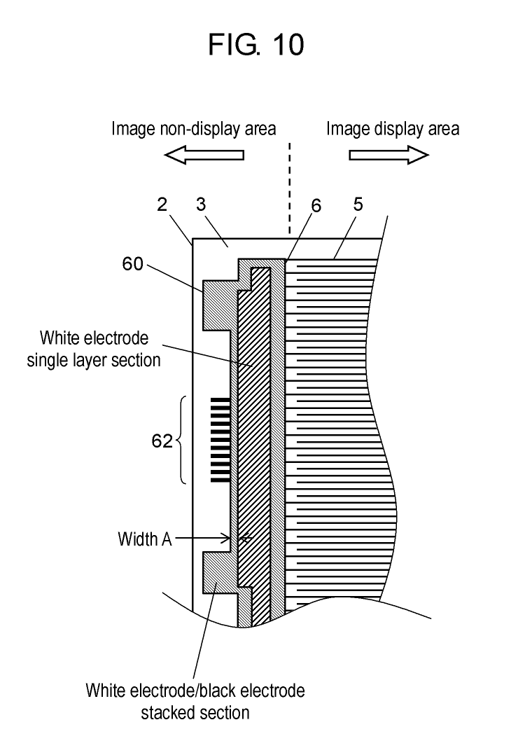

Furthermore, as shown in FIG. 10, sustain electrode common section 60 may be configured so that a region which has a single-layer structure of only the white electrode is surrounded by a region which has a stacked structure of the black electrode and white electrode. This configuration suppresses the increase in resistance and heat generation in sustain electrode common section 60. Furthermore, the suppression effect against peeling of the sustain electrode common section is also achieved because the periphery of sustain electrode common section 60 has the stacked structure.

The structure shown FIG. 10 can be, in the case of using a screen printing method, formed by partially masking a screen printing plate during the application of the black electrode paste. In addition, the width A shown in FIG. 10 is desirably 500 μm or more. If the width A is less than 500 μm, peeling of sustain electrode common section 60 is more likely to be caused. Furthermore, the width A is desirably 1200 μm or more, considering the precision of the screen printing and the change over time of the screen printing plate. As a matter of course, the reduced width A increases the effect lowering the resistance of sustain electrode common section 60.

### 5. Modification Example of Embodiment

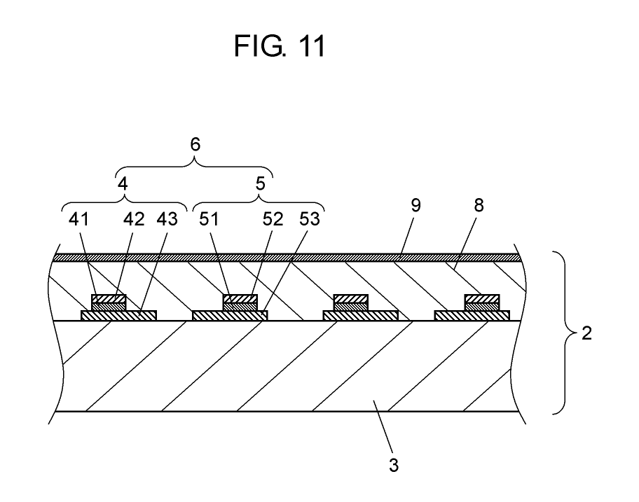

As shown in FIG. 11, transparent electrodes 43, 53 are provided on front glass substrate 3 in the modification example. ITO (Indium Tin Oxide) and the like are used as the material of transparent electrodes 43, 53. ITO is deposited on front glass substrate 3 by a deposition method, a sputtering method, or the like, and then subjected to patterning by a photolithography method. It is to be noted that there is no difference in L value and sparse degree described above, even in the case of including transparent electrodes 43, 53.

In the case of using black electrodes 41, 51 and white electrodes 42, 52 as described above, a phenomenon is observed in which the constituents of the respective electrodes penetrate into each other to reach transparent electrodes 43, 53, and increase the contact resistance between transparent electrodes 43, 53 and the respective electrodes, at the interfaces between black electrodes 41, 51 and white electrodes 42, 52 and transparent electrodes 43, 53 in the step of firing these electrodes.

When black electrode pattern 34 and white electrode pattern 36 are subjected to a firing treatment in the same step, some constituents in black electrode pattern 34 penetrate into not only white electrode pattern 36 but also transparent electrodes 43, 53. This is considered to be because, in the case of a severe phenomenon, the glass constituent contained in black electrodes 41, 51 reaches the surface of front glass substrate 3 to decrease the contact area between transparent electrodes 43, 53 and black electrodes 41, 51.

The study by the inventors has clarified that, in particular, this phenomenon is dominated by the ratio of thickness of white electrodes 42, 52 to the thickness of black electrodes 41, 51 (hereinafter, referred to as ratio R).

In the present embodiment, the amount of the conductive constituent in white electrodes 42, 52 is smaller than ever before. This amount produces a gap between conductive particle 39 and conductive particle 39, thereby making it possible to efficiently discharge the polymer constituent contained in black electrode pattern 34 in the firing process.

However, the smaller amount of the conductive constituent means the relatively increased glass constituent in white electrodes 42, 52. Therefore, more of the glass constituent in white electrodes 42, 52 will penetrate into black electrodes 41, 51. In this case, when black electrodes 41, 51 are thicker, the glass constituent can be absorbed which has penetrated therein. However, when black electrodes 41, 51 are thinner, the glass constituent will further penetrate into transparent electrodes 43, 53. Thus, the glass constituent inserted in gaps between constituents such as ITO increases the contact resistance between transparent electrodes 43, 53 and black electrodes 41, 51.

As just described, when white electrodes 42, 52 are thicker (higher in glass constituent), whereas black electrodes 41, 51 are thinner, the phenomenon of the increase in contact resistance is remarkably produced. Thus, this phenomenon can be suppressed with low ratio R of the thickness of white electrodes 42, 52 to the thickness of black electrodes 41, 51, and with the adequately large thickness (hereinafter, referred to as thickness d) of transparent electrodes 43, 53.

On the other hand, in the case of lower ratio R and larger thickness d, there is a possibility of decreasing the efficiency of discharging the polymer constituent contained in black electrode pattern 34 in the firing process.

When white electrodes 42, 52 are thinner, the absolute quantity of conductive particles 39 in white electrode pattern 36 is smaller in the firing process under the same condition. Therefore, conductive particles 39 are early sintered completely. Accordingly, there is a decrease in the efficiency of discharging the polymer constituent from black electrode pattern 34. Alternatively, when black electrodes 41, 51 are thicker, there is an increase in the absolute quantity of the polymer constituent contained in black electrode pattern 34. Therefore, there is a possibility of insufficient discharge of the polymer constituent.

Furthermore, when transparent electrodes 43, 53 are larger in thickness d, the heat capacity of the whole electrode is increased as compared with a case of being smaller in thickness d. Therefore, black electrodes 41, 51 and white electrodes 42, 52 formed on transparent electrodes 43, 53 may be insufficiently fired in some cases. Thus, increased residues from the whole electrode lead to an increase in the number of projections in dielectric layer 8.

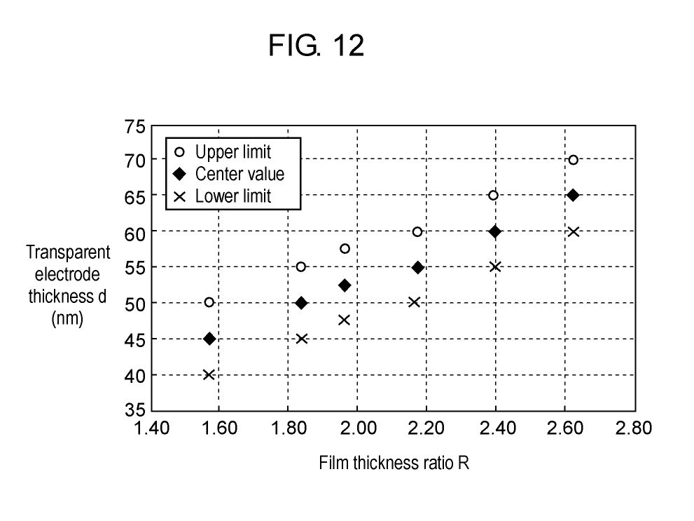

As described above, ratio R and thickness d are preferably kept within the relationship or range shown in Table 1 and FIG. 12.

TABLE 1

| | Sample 1 | Sample 2 | Sample 3 | Sample 4 | Sample 5 | Sample 6 |
|---|---|---|---|---|---|---|
| Black electrode thickness (μm) | 2.5 | 1.5 | 2 | 1.5 | 1.5 | 1.5 |
| White electrode thickness (μm) | 3.9 | 2.8 | 3.9 | 3.3 | 3.6 | 3.9 |
| Ratio R | 1.574 | 1.860 | 1.967 | 2.178 | 2.400 | 2.623 |
| Lower limit of thickness d (nm) | 40 | 45 | 47.5 | 50 | 55 | 60 |
| Center value of thickness d (nm) | 45 | 50 | 52.5 | 55 | 60 | 65 |
| Upper limit of thickness d (nm) | 50 | 55 | 57.5 | 60 | 65 | 70 |

If transparent electrode thickness d exceeds the upper limit with respect to each ratio R, the number of projections is increased in dielectric layer 8. On the other hand, if transparent electrode thickness d falls below the lower limit, the electrode itself undergoes an increase in resistance value. As shown in FIG. 12, the relationship between d and R is d=18.8R+a. In this case, a is 10.2 to 20.2.

In addition, in the present embodiment, the configuration has been demonstrated in which sustain electrode common section 60 at least partially has a single-layer structure of the white electrode. In the modification example, sustain electrode common section 60 has no region for single-layer structures of white electrodes 42, 52, but stacked structures of transparent electrodes 43, 53 and white electrodes 42, 52 or stacked structures of transparent electrodes 43, 53, black electrodes 41, 51, and white electrodes 42, 52. This configuration suppresses the increase in resistance and heat generation in sustain electrode common section 60. Furthermore, the suppression effect against peeling of the sustain electrode common section 60 is also achieved.

### 6. Electrode Gap

In order to suppress short circuit between electrodes (short-circuited display electrode 6), black electrodes 41, 51 and white electrodes 42, 52 in the present embodiment preferably have a gap of 72 μm or more after the development step, in the region (such as an interconnect electrode section leading to scan electrode terminals) with the narrowest electrode (black electrodes and white electrodes) gaps. The reason of controlling the gaps after the development step, rather than the interelectrode gaps after the firing process, is because the control after the development step is preferred due to the shrinkage of the electrodes in the firing process.

In addition, the study by the inventors has found that the shrinkage ratio of the electrode width shrunk by the firing process depends on the electrode width.

Therefore, in the present embodiment, the gap after the firing in the region with the narrowest electrode gap is defined as shown in Table 2 below. More specifically, the electrode gap after the firing process is preferably 103 μm or more. This electrode gap suppresses the generation of short circuit between electrodes.

TABLE 2

| | Sample 1 | Sample 2 | Sample 3 | Sample 4 | Sample 5 |
|---|---|---|---|---|---|
| After | 231 | 265 | 287 | 320 | 342 |
| development | | | | | |
| step | | | | | |
| electrode | | | | | |
| width (μm) | | | | | |
| After | 72 | 72 | 72 | 72 | 72 |
| development | | | | | |
| step | | | | | |
| electrode | | | | | |
| gap (μm) | | | | | |
| After | 200 | 230 | 250 | 280 | 300 |
| firing | | | | | |
| process | | | | | |
| electrode | | | | | |
| width (μm) | | | | | |
| After | 1 | 107 | 109 | 112 | 114 |
| firing | | | | | |
| process | | | | | |
| electrode | | | | | |
| gap (μm) | | | | | |
| Shrinkage | 86.55 | 86.91 | 87.16 | 87.52 | 87.76 |
| ratio (%) | | | | | |

### 7. Effects, etc.

The PDP according to the present embodiment includes: front plate 2 including an image display area and an image non-display area provided outside the image display area; and rear plate 10 provided to be opposed to front plate 2. Front plate 2 has front glass substrate 3 and display electrode 6 provided over front glass substrate 3. Display electrode 6 has stacked structures of black electrodes 41, 51 as first electrodes and white electrodes 42, 52 as second electrodes, which are provided over black electrodes 41, 51. Furthermore, display electrode 6 has, in at least a portion of the image non-display area, a first region and a second region provided around the first region. The first region has a single-layer structure of a white electrode. The second region has a stacked structure of a black electrode and a white electrode. The surface of display electrode 6 has a sparse degree between 12% and 15% (inclusive).

This configuration suppresses the increase in the resistance of, and heat generation from display electrode 6 in the image non-display area. Furthermore, peeling of display electrode 6 is suppressed in the image non-display area. Furthermore, the generation of defects is suppressed which are caused by display electrode 6.

The other PDP according to the present embodiment includes: front plate 2 including an image display area and an image non-display area provided outside the image display area; and rear plate 10 provided to be opposed to front plate 2. Front plate 2 has front glass substrate 3 and display electrode 6 provided over front glass substrate 3. Display electrode 6 has stacked structures of black electrodes 41, 51 as first electrodes and white electrodes 42, 52 as second electrodes, which are provided over black electrodes 41, 51. Furthermore, display electrode 6 has, in at least a portion of the image non-display area, a first region and a second region provided around the first region. The first region has a single-layer structure of a white electrode. The second region has a stacked structure of a black electrode and a white electrode. The surface of display electrode 6 has a brightness as an L value between 68 and 71 (inclusive).

This configuration suppresses the increase in the resistance of, and heat generation from display electrode 6 in the image non-display area. Furthermore, peeling of display electrode 6 is suppressed in the image non-display area. Furthermore, the generation of defects is suppressed which are caused by display electrode 6.

Further, front plate 2 may further include transparent electrodes 43, 53 between front glass substrate 3 and display electrode 6. Transparent electrodes 43, 53 preferably have a film thickness between 40 nm and 70 nm (inclusive).

Furthermore, preferably, display electrode 6 is divided into multiple electrodes at intervals of 103 μm or more in the image display area.

In the method for manufacturing a PDP according to the present embodiment, white electrode pattern 36 as a second pattern containing a plurality of conductive particles 39 arranged apart from each other so as to provide gaps is formed on black electrode pattern 34 as a first pattern containing a polymer and a black pigment as an inorganic constituent, the first pattern formed on front glass substrate 3. The method includes then forming black electrodes 41, 51 as a first layer and white electrodes 42, 52 as a second layer from black electrode pattern 34 and white electrode pattern 36 respectively by co-firing black electrode pattern 34 and white electrode pattern 36. In co-firing black electrode pattern 34 and white electrode pattern 36, the polymer is changed to a gas by burning, and the gas is at least partially desorbed through the gaps from black electrode pattern 34.

The method facilitates degassing from black electrode pattern 34 as the lower layer, even in the case of co-firing black electrode pattern 34 and white electrode pattern 36. Therefore, the generation of defects is suppressed which are caused by display electrode 6.

Further, conductive particles 39 preferably have an average particle size between 1 μm and 3 μm (inclusive).

This is because the conductive particles less than 1 μm in average particle size are likely to be aggregated in the electrode paste. This is because the conductive particles greater than 3 μm average particle size have difficulty with uniform dispersion in the electrode paste.

Moreover, conductive particles 39 more preferably have small particles between 1 μm and 1.5 μm (inclusive) in average particle size and large particles between 2 μm and 3 μm (inclusive) in average particle size.

The small particles stuck in the gaps between the large particles further reduce defects of white electrodes 42, 52.

It is to be noted that a case of display electrode 6 formed by a photolithography method has been described as an example in the present embodiment. More specifically, a case of using photosensitive pastes as the black paste and the electrode paste has been described as an example. However, the black paste and the electrode paste are not limited to photosensitive pastes. In the case of forming black paste layer 30 and/or electrode paste layer 32 by a pattern printing method or the like, the need is eliminated for the photopolymerizable monomer and photopolymerization initiator. More specifically, the black paste only has to contain a black pigment, a resin, and a solvent. The electrode paste only has to contain a conductive resin, a resin, and a solvent.

Furthermore, a case of using a black pigment as the inorganic constituent has been described as an example in the present embodiment. However, the inorganic constituent is not limited to black pigments. The inorganic constituent may be oxides for use as fillers, metals, and the like.

As described above, the embodiment has been described as an example of the technique disclosed herein. To this end, the accompanying drawings and the detailed description are provided.

Therefore, the constituent elements disclosed in the accompanying drawings and the detailed description can include constituent elements which are not essential for solving the problem. The constituent elements are intended to illustrate the technique described above. Although the constituent elements which are not essential are disclosed in the accompanying drawings and the detailed description, the constituent elements which are not essential should not be considered essential.

In addition, the embodiment described above is intended to illustrate the technique disclosed herein. Therefore, various modifications, substitutions, additions, omissions, etc. can be made within the scope of the claims and equivalents thereto.

### INDUSTRIAL APPLICABILITY

The technique disclosed in the present embodiment as described above is available for large-screen display devices, etc.

### REFERENCE MARKS IN THE DRAWINGS

1 PDP
2 front plate
2 front glass substrate
4 scan electrode
41, 51 black electrode
42, 52 white electrode
43, 53 transparent electrode
5 sustain electrode
6 display electrode
8 dielectric layer
9 protective layer
10 rear plate
11 rear glass substrate
12 address electrode
13 insulating layer
14 barrier rib
15 phosphor layer
16 discharge space
30 black paste layer
32 electrode paste layer
34 black electrode pattern
36 white electrode pattern
39 conductive particle
60 sustain electrode common section
62 terminal section

1. A plasma display panel comprising:
a front plate including an image display area and an image non-display area provided outside the image display area; and
a rear plate provided so as to be opposed to the front plate,
wherein the front plate has a substrate and a display electrode provided over the substrate,
the display electrode has a stacked structure of a first electrode and a second electrode provided over the first electrode in the image display area,
the display electrode further has a first region and a second region provided around the first region in at least a portion of the image non-display area,
the first region has a single-layer structure of the second electrode,
the second region has a stacked structure of the first electrode and the second electrode provided over the first electrode, and
a surface of the display electrode has a sparse degree between 12% and 15% (inclusive).

2. The plasma display panel according to claim 1,
wherein the front plate further includes a transparent electrode between the substrate and the display electrode, and the transparent electrode has a film thickness between 40 nm and 70 nm (inclusive).

3. The plasma display panel according to claim 1,
wherein the display electrode is further divided into multiple electrodes at intervals of 103 μm or more in the image display area.

4. The plasma display panel according to claim 2,
wherein the display electrode is further divided into multiple electrodes at intervals of 103 μm or more in the image display area.

5. A plasma display panel comprising:
a front plate including an image display area and an image non-display area provided outside the image display area; and
a rear plate provided so as to be opposed to the front plate,
wherein the front plate has a substrate and a display electrode provided over the substrate,
the display electrode has a stacked structure of a first electrode and a second electrode provided over the first electrode in the image display area,
the display electrode further has a first region and a second region provided around the first region in at least a portion of the image non-display area,
the first region has a single-layer structure of the second electrode,
the second region has a stacked structure of the first electrode and the second electrode provided over the first electrode, and
a surface of the display electrode has a brightness as an L value between 68 and 71 (inclusive).

6. The plasma display panel according to claim 5,
wherein the front plate further has a transparent electrode between the substrate and the display electrode, and the transparent electrode has a film thickness between 40 nm and 70 nm (inclusive).

7. The plasma display panel according to claim 5,
wherein the display electrode is further divided into multiple electrodes at intervals of 103 μm or more in the image display area.

8. The plasma display panel according to claim 7,
wherein the display electrode is further divided into multiple electrodes at intervals of 103 μm or more in the image display area.

9-11. (canceled)
